(19) United States
(12) Patent Application Publication
(10) Pub. No.: US 2003/0151489 A1
(43) Pub. Date: Aug. 14, 2003

(54) Using a wireless interface for monitoring, maintenance, and control of devices

(76) Inventors: Eyal Shbiro, Petah-Tikva (IL); Jacob Fainguelernt, Kfar-Saba (IL)

Correspondence Address: LEFFERT JAY & POLGLAZE, P.A., P.O. BOX 581009, MINNEAPOLIS, MN, 55458-1009, US

(21) Appl. No.: 10/071,886

(22) Filed: Feb. 8, 2002

(51) Int. Cl. G05B 23/02; G08C 19/00

(52) U.S. Cl. 340/3.1; 340/825.69

(57) ABSTRACT

A wireless system having at least one device that is adapted to wirelessly receive at least one signal that alters at least one condition of the device and that is adapted to wirelessly transmit at least one signal that is indicative of at least one condition of the device. The wireless system also having a tool in wireless communication with the device that is adapted to receive the indicative signal from the device and that is adapted to transmit the alterative signal to the device.

### TECHNICAL FIELD

The present invention relates generally to the field of wireless systems and, in particular, to wireless systems used for systems monitoring and maintenance.

### BACKGROUND

Device performance is often monitored and altered by connecting personal computers or terminals to the device using a cable that connects a port on the device to the personal computer or terminal. For example, personal computers or terminals are frequently cable-connected to ports on devices to alter their operation for maintenance purposes. Some devices include a number of components, and the performance of the components is monitored or altered by a computer that is cable-connected to a port that is coupled to the components, e.g., a housing that protects the components, such as telecommunications components, from harmful phenomena. Frequently, devices, such as protective housings containing telecommunications components, are located in remote locations, e.g., below ground, suspended from cables strung between utility poles, or the like, or in hazardous environments, e.g., environments having toxic chemicals. These situations make it difficult for a cable to be connected to ports of the devices.

For the reasons stated above, and for other reasons stated below which will become apparent to those skilled in the art upon reading and understanding the present specification, there is a need in the art for systems that allow easier access for monitoring and altering device performance for one or more devices located in remote locations and/or hazardous environments.

### SUMMARY

The above-mentioned problems with using cables to connect personal computers or terminals to devices located in remote locations and/or hazardous environments and other problems are addressed by embodiments of the present invention and will be understood by reading and studying the following specification. Embodiments of the present invention provide a wireless system that can be used to wirelessly monitor and alter the performance of devices located in remote locations and/or hazardous environments.

More particularly, in one embodiment the wireless system has at least one device that is adapted to wirelessly receive at least one signal that alters at least one condition of the device and that is adapted to wirelessly transmit at least one signal that is indicative of at least one condition of the device. The wireless system also has a tool in wireless communication with the device that is adapted for at least one of monitoring and control of the device, that is adapted to receive the indicative signal from the device, and that is adapted to transmit the alterative signal to the device.

### BRIEF DESCRIPTION OF THE DRAWINGS

FIG. 1 is an illustration demonstrating a first embodiment of the present invention.

FIG. 2 is an illustration demonstrating a second embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention address problems associated with using cables to connect personal computers or terminals to ports of devices to monitor and alter the performance of these devices. Using cables to connect personal computers or terminals to ports of devices involves a technician having to route cables between the ports and the personal computers or terminals and to physically connect the cables to the ports. Problems arise when devices are located in remote locations, e.g., below ground, suspended from utility poles, or the like, or in hazardous environments, e.g., environments having toxic chemicals, because it is difficult for the technician to route the cables and connect them to the ports.

Embodiments of the present invention replace cable connections with a wireless link that connects a personal computer or terminal to the devices. The wireless link allows the performance of these devices to be monitored and altered from a remote location and avoids the need for a technician to route and connect cables. Moreover, wireless links may be established between a computer or terminal and a multitude of devices simultaneously. The present invention utilizes readily available, relatively inexpensive components to establish the wireless links.

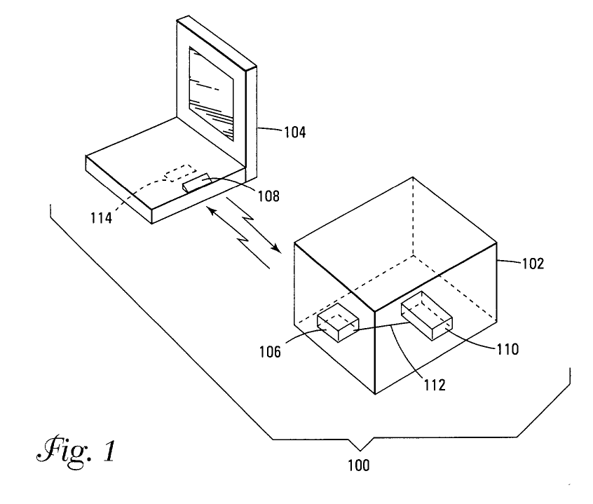

Wireless system 100, shown in FIG. 1, demonstrates a first embodiment of the present invention. Wireless system 100 includes device 102, e.g., a network element a communications network, laboratory test equipment, a power supply, a housing containing other electronic components, etc., that is adapted to receive and transmit signals. Wireless system 100 also includes a tool, exemplified by portable computer 104, that is in wireless communication with device 102. Portable computer 104 is adapted to receive at least one signal from device 102 that is indicative of at least one condition of device 102. Portable computer 104 is adapted to transmit at least one signal. In one embodiment, the transmitted signals alter at least one condition of device 102. In other embodiments, the signal transmitted to device 102 provides downloads, e.g., software upgrades or other commands or queries relating to the operation, configuration, or functioning of device 102.

In one embodiment, device 102 is located in a remote location, e.g., below ground, suspended from a cable strung between utility poles, or the like. In another embodiment, alteration of the condition is preformed to maintain device 102 in proper working order. In another embodiment, portable computer 104 respectively receives and transmits signals at different frequencies. In another embodiment, portable computer 104 monitors device 102, e.g., computer 104 receives data from device 102 and stores the data received.

Device 102 includes transceiver 106, and portable computer 104 includes transceiver 108. Transceivers 106 and 108 are wirelessly coupled to each other. Transceiver 106 transmits at least one signal from device 102 to transceiver 108 that is indicative of at least one condition of device 102 (referred to hereinafter as the “indicative” signal), where the condition relates to the operation, configuration, or functioning of or to information possessed by the respective device or the like, e.g., voltage, current, usage, or the like. Transceiver 108 transmits the indicative signal to portable computer 104 that alters at least one condition of device 102.

Portable computer 104 transmits at least one signal to transceiver 108. Transceiver 108 transmits this signal to transceiver 106. Transceiver 106 transmits this signal to device 102. In another embodiment, transceiver 108 respectively receives and transmits signals at different frequencies. In one embodiment, the signal transmitted to device 102 alters at least one condition of device 102. In other embodiments, the signal transmitted to device 102 provides downloads, e.g., software upgrades or other commands or queries relating to the operation, configuration, or functioning of device 102 with or without an indicative signal.

Transceiver 106 may be any suitable transceiver, e.g., transceiver 106 may be a BLUETOOTH OEM module available from Stonestreet One that includes hardware and software. In one embodiment, transceiver 106 is coupled to device 102 using any suitable interface, e.g., the BLUETOOTH OEM module available from Stonestreet One uses UART, RS-232, or USB. Transceiver 108 may be any transceiver that can interface with portable computer 104, e.g., the BLUETOOTH PC CARD available from Motorola, Inc.

Device 102 includes at least one component 110 that may be any electrical component, e.g., a circuit card, amplifier, electrical-to-optical converter, optical-to-electrical converter, a switch, analog-to-digital converter, etc. In one embodiment, device 102 is a housing located in a remote location, e.g., below ground, suspended from a cable strung between utility poles, or the like, that contains at least one component 110. Component 110 is coupled to transceiver 106 by interface 112. Interface 112 may be any suitable interface, e.g., the BLUETOOTH OEM module available from Stonestreet One uses UART, RS-232, or USB. Portable computer 104 also includes evaluator 114. Evaluator 114 may be a PC card or software code that receives the indicative signal from transceiver 108 and compares the indicative signal to a preselected value for the indicative signal. If there is an unacceptable deviation between the indicative signal and the preselected value, evaluator 114 transmits an alterative signal to transceiver 108 that alters at least one condition of component 110.

In operation of one embodiment of wireless system 100, at least one signal that is indicative of the condition of device 102 is transmitted to transceiver 106. The indicative signal is transmitted wirelessly from transceiver 106 to transceiver 108. The indicative signal is transmitted from transceiver 108 to portable computer 104. Portable computer 104 transmits at least one signal that alters at least one condition of device 102 to transceiver 108. The alterative signal is transmitted from transceiver 108 to transceiver 106. The alterative signal is transmitted from transceiver 106 to device 102 that alters at least one condition of device 102.

In another embodiment, portable computer 104 monitors device 102, e.g., computer 104 receives data from device 102 and stores the data received. In another embodiment, evaluator 114 of portable computer 104 evaluates the indicative signal, and the alterative signal alters at least one condition of device 102 based on the evaluation. In other embodiments, the signal transmitted to device 102 provides downloads, e.g., software upgrades or other commands or queries relating to the operation, configuration, or functioning of device 102 with or without an indicative signal.

More specifically, transceiver 106 is coupled to component 110 using interface 112, e.g., the BLUETOOTH OEM module available from Stonestreet One using UART, RS-232, or USB. Transceiver 108 is coupled to portable computer 104, such as by inserting a PC card into computer 104 that includes transceiver 108, e.g., the BLUETOOTH PC CARD available from Motorola, Inc. Transceivers 106 and 108 are configured so that they communicate with each other. For example, using the BLUETOOTH configuration for communication between the BLUETOOTH OEM module and the BLUETOOTH PC CARD. Wireless communication between transceivers 106 and 108 is accomplished by positioning portable computer 104 at a selected distance from device 102 that is within the communication range of transceivers 106 and 108. For example, the communication range for the BLUETOOTH OEM module and the BLUETOOTH PC CARD may be anywhere from 10 centimeters to over 100 meters.

At least one signal that is indicative of the condition of component 110 is transmitted to transceiver 106 via interface 112. The indicative signal is transmitted wirelessly from transceiver 106 to transceiver 108. The indicative signal is transmitted from transceiver 108 to portable computer 104. In one embodiment, the signal received at transceiver 108 is transmitted to evaluator 114. Evaluator 114 evaluates the indicative signal by comparing the indicative signal to a preselected value for the indicative signal. If there is an unacceptable deviation between the indicative signal and the preselected value, the evaluator transmits an alterative signal to transceiver 108. For example, the indicative signal may be indicative of the current output of a power supply for a given voltage that is to be below the preselected value. If the indicative signal indicates a current above the preselected value, evaluator 114 transmits an alterative signal to transceiver 108 that reduces the current value.

Evaluator 114 transmits at least one alterative signal based on the evaluation that alters at least one condition of component 110 to transceiver 108. The alterative signal is transmitted from transceiver 108 to transceiver 106. The alterative signal is transmitted from transceiver 106 to component 110 via interface 112 that alters at least one condition of component 110.

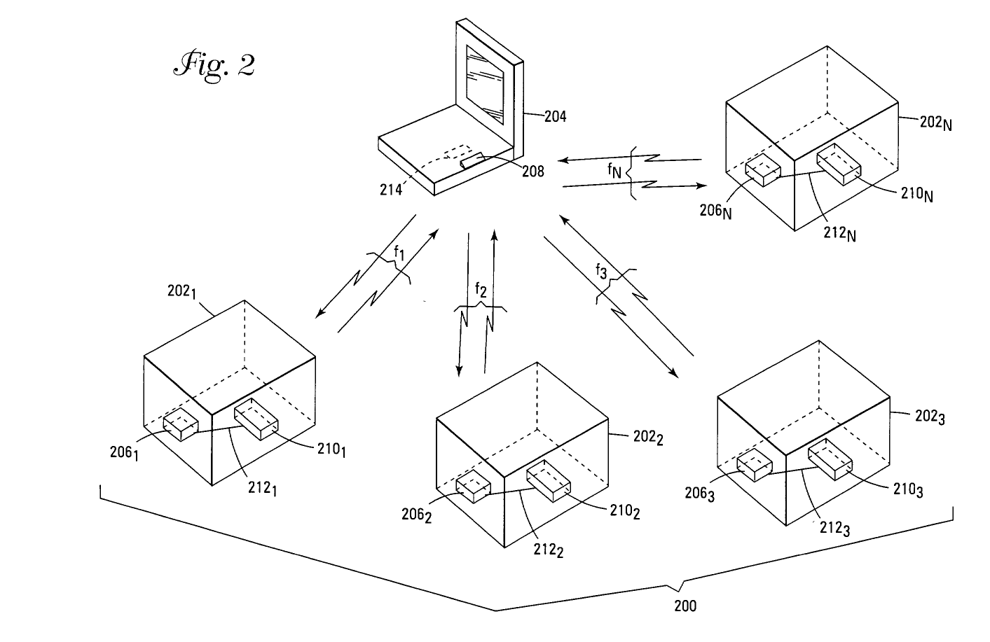

Wireless system 200, shown in FIG. 2, demonstrates a second embodiment of the present invention. Wireless system 200 includes devices 202₁ through 202_{N}, e.g., devices 202₁, through 202_{N} may be power supplies, voltmeters, housings for electronic components, etc., that are adapted to receive and transmit signals. Wireless system 200 also includes a tool, exemplified by portable computer 204, that is in wireless communication with each of devices 202₁, through 202_{N}.

Portable computer 204 communicates with each of devices 202₁, through 202_{N} respectively using frequencies f₁ through f_{N}. Portable computer 204 is adapted to respectively receive signals from each of devices 202₁ through 202_{N} at frequencies f₁ through f_{N}. Each of these signals is respectively indicative of at least one condition of each of devices 202₁ through 202_{N}, where the condition relates to the operation, configuration, or functioning of or to information possessed by the respective device or the like, e.g., voltage, current, usage or the like. Portable computer 204 is adapted to respectively transmit signals at frequencies f₁ through f_{N} to each of devices 202₁ through 202_{N}. In one embodiment, the transmitted signals alter at least one condition of each of devices 202₁ through 202_{N}. In other embodiments, the signals transmitted to devices 202₁ through 202_{N} provide downloads, e.g., software upgrades or other commands or queries relating to the operation, configuration, or functioning of devices 202₁ through 202_{N}.

In one embodiment, devices 202₁ through 202_{N} are located in a remote location, e.g., below ground, suspended from a cable strung between utility poles, or the like. In another embodiment, alteration of the respective conditions is performed to maintain respective devices 202₁ through 202_{N} in proper working order. In another embodiment, portable computer 204 respectively receives signals at frequencies g₁ through g_{N} and respectively transmits signals at frequencies h₁ through h_{N} to each of devices 202₁ through 202_{N}. In another embodiment, portable computer 204 monitors each of devices 202₁ through 202_{N}, e.g., computer 204 receives data from each of devices 202₁ through 202_{N} and stores the data received.

Each of devices 202₁ through 202_{N} respectively includes transceivers 206₁ through 206_{N}. Portable computer 204 includes transceiver 208. Transceivers 206₁ through 206_{N} are wirelessly coupled to transceiver 208. In one embodiment, each of transceivers 206₁ through 206_{N} respectively transmits signals from devices 202₁ through 202_{N} to transceiver 208 at frequencies f₁ through f_{N}. Each of these signals is respectively indicative of at least one condition of each of devices 202₁ through 202_{N} (referred to hereinafter as the “indicative” signal), where the condition relates to the operation, configuration, or functioning of or to information possessed by the respective device or the like, e.g., voltage, current, usage or the like. Transceiver 208 transmits each of the indicative signals to portable computer 204.

Portable computer 204 transmits signals to transceiver 208. Transceiver 208 respectively transmits each of these signals to each of transceivers 206₁ through 206_{N} at frequencies f₁ through f_{N}. Transceivers 206₁ through 206_{N} respectively transmit each of these signals to devices 202₁ through 202_{N}. In one embodiment, the signals transmitted to devices 202₁ through 202_{N} alter at least one condition of each of devices 202₁ through 202_{N}. In other embodiments, the signals transmitted to devices 202₁ through 202_{N} provide downloads, e.g., software upgrades or other commands or queries relating to the operation, configuration, or functioning of devices 202₁ through 202_{N}.

Each of transceivers 206₁ through 206_{N} may be any suitable transceiver, e.g., each of transceivers 206₁ through 206_{N} may be a BLUETOOTH OEM module available from Stonestreet One that includes hardware and software. In one embodiment, each of transceivers 206₁ through 206_{N} is respectively coupled to each of devices 202₁ through 202_{N} using suitable interfaces, e.g., the BLUETOOTH OEM modules available from Stonestreet One use UART, RS-232, or USB. Transceiver 208 may be any transceiver that can interface with portable computer 204 or the like, e.g., the BLUETOOTH PC CARD available from Motorola, Inc.

Portable computer 204 also includes evaluator 214. Evaluator 214 may be a PC card or software code that receives each of the indicative signals from transceiver 208 and respectively compares each of the indicative signals to preselected values for each of the indicative signals. If there is an unacceptable deviation between the indicative signals and the corresponding preselected values, the evaluator transmits corresponding alterative signals to transceiver 208 that respectively alter at least one condition of each of devices 202₁ through 202_{N}.

Each of devices 202₁ through 202_{N} respectively includes at least one of components 210₁ through 210_{N} that may be electrical components, e.g., a circuit card, amplifier, electrical-to-optical converter, optical-to-electrical converter, a switch, analog-to-digital converter, etc. In one embodiment, devices 202₁ through 202_{N} are housings located in a remote location, e.g., below ground, suspended from a cable strung between utility poles, or the like, that respectively contain components 210₁ through 210_{N}. Each of components 210₁ through 210_{N} is respectively coupled to transceivers 206₁ through 206_{N} by interfaces 212₁ through 212_{N}. Interfaces 212₁ through 212_{N} may be interfaces of any suitable type, e.g., the BLUETOOTH OEM module available from Stonestreet One uses UART, RS-232, or USB.

In operation of wireless system 200, signals are respectively transmitted from devices 202₁ through 202_{N} to transceivers 206₁ through 206_{N}, the signals respectively indicative of at least one condition of devices 202₁ through 202_{N}. The indicative signals are respectively transmitted from transceivers 206₁ through 206_{N} at frequencies f₁ through f_{N} wirelessly to transceiver 208. The indicative signals are transmitted from transceiver 208 to portable computer 204. Alterative signals that respectively alter at least one condition of devices 202₁ through 202_{N} are transmitted from portable computer 204 to transceiver 208. The alterative signals are respectively transmitted from transceiver 208 at frequencies f₁ through f_{N} to transceivers 206₁ through 206_{N} wirelessly. The alterative signals are respectively transmitted to devices 202₁ through 202_{N} to respectively alter at least one condition of devices 202₁ through 202_{N}.

In another embodiment, portable computer 204 monitors each of devices 202₁ through 202_{N}, e.g., computer 204 receives data from each of devices 202₁ through 202_{N} and stores the data received. In another embodiment, evaluator 214 of portable computer 204 respectively evaluates each of the indicative signals, and each of the alterative signals respectively alters at least one condition of devices 202₁ through 202_{N} based on the evaluation. In other embodiments, the signals transmitted to devices 202₁ through 202_{N} provide downloads, e.g., software upgrades or other commands or queries relating to the operation, configuration, or functioning of devices 202₁ through 202_{N}.

More specifically, each of transceivers 206₁ through 206_{N} is respectively coupled to components 210₁ through 210_{N} using interfaces 212₁ through 212_{N}, e.g., BLUETOOTH OEM modules available from Stonestreet One using UART, RS-232, or USB. Transceiver 208 is coupled to portable computer 204, such as by inserting a PC card into computer 204 that includes transceiver 208, e.g., the BLUETOOTH PC CARD available from Motorola, Inc. Each of transceivers 206₁ through 206_{N} and transceiver 208 are configured so that each of transceivers 206₁ through 206_{N} communicates with transceiver 208 individually, e.g., using the BLUETOOTH configuration for communication between more than BLUETOOTH OEM module and the BLUETOOTH PC CARD. Wireless communication between each of transceivers 206₁ through 206_{N} and transceiver 208 is accomplished by positioning portable computer 204 at a selected distance from each of devices 202₁ through 202_{N} that is respectively within the communication range of transceivers 206₁ through 206_{N} and transceiver 208. For example, the communication range for the BLUETOOTH OEM module and the BLUETOOTH PC CARD may be anywhere from 10 centimeters to over 100 meters.

Signals are respectively transmitted from components 210₁ through 210_{N} to transceivers 206₁ through 206_{N} via interfaces 212₁ through 212_{N}, the signals respectively indicative of at least one condition of components 210₁ through 210_{N}. The indicative signals are respectively transmitted from transceivers 206₁ through 206_{N} at frequencies f₁ through f_{N} wirelessly to transceiver 208. The indicative signals are transmitted from transceiver 208 to portable computer 204.

In one embodiment, the signals received at transceiver 208 are transmitted to evaluator 214 that evaluates each of the indicative signals by respectively comparing each of the indicative signals to preselected values for each of the indicative signals. If there is an unacceptable deviation between the indicative signals and the corresponding preselected value, evaluator 214 transmits a corresponding alterative signal to transceiver 208. For example, the indicative signal for devices 202₁ and 202₂ may be respectively indicative of the current output of a power supply for a given voltage that is to be below the preselected voltage value and the gain of an amplifier that is to be above the preselected gain value. If the indicative signals respectively indicate a current above the preselected voltage value and a gain below the preselected gain value, evaluator 214 transmits alterative signals to transceiver 208 that respectively reduce the current value and increase the gain value.

The alterative signals are respectively transmitted from transceiver 208 to transceivers 206₁ through 206_{N}. The alterative signals are respectively transmitted from transceivers 206₁ through 206_{N} to components 210₁ through 210_{N} via interfaces 212₁ through 212_{N} to alter at least one condition of components 210₁ through 210_{N}.

### Conclusion

Embodiments of the present invention have been described. The embodiments provide a wireless system that can be used to wirelessly monitor and alter the performance of devices located in remote locations and/or hazardous environments.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. For example, desktop computers or terminals may replace portable computers 104 and 204, and suitable HOMERF components or IEEE 802.11 components may replace the BLUETOOTH components.

What is claimed is:

1. A wireless system comprising:
at least one device that includes at least one electrical component;
a first transceiver coupled to the at least one device, the transceiver adapted to wirelessly receive at least one first signal for the at least one device and adapted to wirelessly transmit at least one second signal for the at least one device;
a tool adapted for at least one of monitoring and control of the at least one device; and
a second transceiver coupled to the tool, the second transceiver in wireless communication with the first transceiver, the second transceiver adapted to receive the at least one second signal from the first transceiver and adapted to transmit the at least one first signal to the first transceiver.

2. The wireless system of claim 1, further comprising an evaluator that evaluates the at least one first signal at the tool, wherein the tool transmits the at least one second signal based on the evaluation.

3. The wireless system of claim 1, wherein the first and second transceivers are adapted to communicate within a selected range.

4. The wireless system of claim 3, wherein the selected range is between approximately 10 cm and 100 m.

5. The wireless system of claim 1, wherein the at least one device comprises a plurality of devices.

6. The wireless system of claim 1, wherein the at least one first signal alters at least one condition of the at least one device.

7. The wireless system of claim 1, wherein the at least one second signal is indicative of at least one condition of the at least one device.

8. A wireless system comprising:
a plurality of devices, each of the plurality of devices adapted to receive and transmit signals wirelessly; and
a tool in wireless communication with the devices, the tool adapted for at least one of monitoring and control of each of the plurality of devices, the tool respectively communicating with each of the plurality of devices using a different frequency, the tool adapted to respectively receive at least one signal at each of the different frequencies from each of the plurality of devices, wherein each of the signals is respectively indicative of at least one condition of each of the plurality of devices, the tool adapted to respectively transmit at least one signal at each of the different frequencies to each of the plurality of devices.

9. The wireless system of claim 8, wherein each of the signals transmitted by the tool respectively alter at least one condition of each of the plurality of devices.

10. The wireless system of claim 8, further comprising a plurality of transceivers, each of the plurality of transceivers respectively coupled to each of the plurality of devices, wherein each of the plurality of transceivers respectively transmits at least one of the indicative signals at each of the different frequencies to the tool, wherein each of the plurality of transceivers respectively receives at least one of the signals transmitted by the tool at each of the different frequencies.

11. The wireless system of claim 10, wherein each of the plurality of devices respectively includes at least one component, wherein each of the components are respectively coupled to each of the plurality of transceivers.

12. The wireless system of claim 8, further comprising a transceiver that is coupled to the tool and that respectively receives each of the indicative signals at each of the different frequencies from each of the plurality of devices and respectively transmits each of the signals transmitted by the tool at each of the different frequencies to each of the plurality of devices.

13. The wireless system of claim 8, further comprising a plurality of first transceivers, each of the plurality of first transceivers respectively coupled to each of the plurality of devices, and further comprising a second transceiver, the second transceiver coupled to the tool and adapted to wirelessly communicate with each of the plurality of first transceivers.

14. The wireless system of claim 13, wherein each of the plurality first transceivers and the second transceiver are adapted to communicate within a selected range.

15. The wireless system of claim 14, wherein the selected range is between approximately 10 cm and 100 m.

16. The wireless system of claim 8, further comprising an evaluator that evaluates each of the indicative signals at the tool, wherein each of the signals transmitted by the tool respectively alter at least one condition of each of the plurality of devices based on the evaluation.

17. A wireless system comprising:
at least one device;
a first transceiver that is coupled to the at least one device, wherein the first transceiver receives at least one signal from the at least one device that is indicative of at least one condition of the at least one device and transmits the at least one indicative signal, wherein the first transceiver receives at least one signal that alters at least one condition of the at least one device and transmits the at least one alterative signal to the at least one device to alter the condition;
a tool adapted for at least one of monitoring and control of the at least one device;
a second transceiver coupled to the tool and wirelessly coupled to the first transceiver, wherein the second transceiver receives the at least one indicative signal from the first transceiver and transmits the at least one indicative signal to the tool, wherein the second transceiver receives the at least one alterative signal from the tool and transmits the at least one alterative signal to the first transceiver; and
an evaluator that evaluates the at least one indicative signal at the tool, wherein the at least one alterative signal is based on the evaluation.

18. A wireless system comprising:
at least one device;
a first transceiver that is coupled to the at least one device, wherein the first transceiver receives at least one first signal from the at least one device and transmits the at least one first signal, wherein the at least one first signal requests data for the at least one device, wherein the first transceiver receives at least one second signal and transmits the at least one second signal to the at least one device, wherein the at least one second signal downloads the data to the at least one device;
a tool adapted for at least one of monitoring and control of the at least one device; and
a second transceiver coupled to the tool and wirelessly coupled to the first transceiver, wherein the second transceiver receives the at least one first signal from the first transceiver and transmits the at least one first signal to the tool, wherein the second transceiver receives the at least one second signal from the tool and transmits the at least one second signal to the first transceiver.

19. A wireless system comprising:
at least one device;
a first transceiver that is coupled to the at least one device, wherein the first transceiver receives at least one data signal and transmits the at least one data signal to the at least one device, wherein the at least one data signal downloads data to the at least one device;
a tool adapted for at least one of monitoring and control of the at least one device; and
a second transceiver coupled to the tool and wirelessly coupled to the first transceiver, wherein the second transceiver receives the at least one data signal from the tool and transmits the at least one data signal to the first transceiver.

20. A wireless system comprising:
a plurality of devices,
a plurality of first transceivers, each of the plurality of first transceivers respectively coupled to each of the plurality of devices, wherein each of the plurality of first transceivers respectively receives at least one signal from each of the plurality of devices that is indicative of at least one condition of each of the plurality of devices and respectively transmits each of the indicative signals at a different frequency, wherein each of the plurality of first transceivers respectively receives at least one signal at each of the different frequencies that alter at least one condition of each of the plurality of devices and respectively transmits each of the alterative signals to each of the plurality of devices to alter each of the conditions;
a tool adapted for at least one of monitoring and control of each of the plurality of devices;
a second transceiver coupled to the tool and wirelessly coupled to each of the plurality of first transceivers, wherein the second transceiver respectively receives each of the indicative signals from each of the plurality of first transceivers at each of the different frequencies and transmits each of the indicative signals to the tool, wherein the second transceiver receives each of the alterative signals from the tool and respectively transmits each of the alterative signals at each of the different frequencies to each of the plurality of first transceivers; and
an evaluator that evaluates each of the indicative signals at the tool, wherein each of the alterative signals are based on the evaluation.

21. A wireless system comprising:
at least one device that includes at least one component;
a first transceiver that is coupled to the at least one component, wherein the first transceiver receives at least one signal from the at least one component that is indicative of at least one condition of the at least one component and transmits the at least one indicative signal, wherein the first transceiver receives at least one signal that alters at least one condition of the at least one component and transmits the at least one alterative signal to the at least one component to alter the at least one condition;
a tool adapted for at least one of monitoring and control of the at least one device;
a second transceiver coupled to the tool and wirelessly coupled to the first transceiver, wherein the second transceiver receives the at least one indicative signal from the first transceiver and transmits the at least one indicative signal to the tool, wherein the second transceiver receives the at least one alterative signal from the tool and transmits the at least one alterative signal to the first transceiver; and
an evaluator that evaluates the at least one indicative signal at the tool, wherein the alterative signal is based on the evaluation.

22. A wireless system comprising:
a plurality of devices, each of the plurality of devices respectively including at least one component;
a plurality of first transceivers, each of the plurality of first transceivers respectively coupled to the at least one component of each of the plurality of devices, wherein each of the plurality of first transceivers respectively receives at least one signal from the at least one component of each of the plurality of devices that is indicative of at least one condition of the at least one component of each of the plurality of devices and respectively transmits each of the indicative signals at a different frequency wirelessly, wherein each of the plurality of first transceivers respectively receives at least one signal at each of the different frequencies wirelessly that alters at least one condition of the at least one component of each of the plurality of devices and respectively transmits each of the alterative signals to the at least one component of each of the plurality of devices to alter the at least one condition of the at least one component of each of the plurality of devices;
a tool adapted for at least one of monitoring and control of the at least one component of each of the plurality of devices;
a second transceiver coupled to the tool and wirelessly coupled to each of the plurality of first transceivers, wherein the second transceiver receives each of the indicative signals from each of the plurality of first transceivers at each of the different frequencies and transmits each of the indicative signals to the tool, wherein the second transceiver receives each of the alterative signals from the tool and respectively transmits each of alterative signals at each of the different frequencies to each of the plurality of first transceivers; and
an evaluator that evaluates the indicative signals at the tool, wherein the alterative signals are based on the evaluation.

23. A method for monitoring and altering conditions of devices from a remote location, the method comprising:
transmitting at least one signal from at least one device to a first transceiver that is indicative of at least one condition of the at least one device;
transmitting the at least one indicative signal wirelessly from the first transceiver to a second transceiver coupled to a tool that is adapted for at least one of monitoring and control of the at least one device;
transmitting the at least one indicative signal from the second transceiver to the tool;
transmitting at least one alterative signal from the tool to the second transceiver;
transmitting the at least one alterative signal wirelessly from the second transceiver to the first transceiver;
transmitting the at least one alterative signal from the first transceiver to the at least one device; and
altering at least one condition of the at least one device using the at least one alterative signal.

24. The method of claim 23, further comprising evaluating the at least one indicative signal at the tool and altering the at least one condition of the at least one device based on the evaluation.

25. The method of claim 23, wherein transmitting at least one signal from at least one device includes transmitting the at least one signal from at least one component of the at least one device.

26. The method of claim 23, wherein transmitting at least one alterative signal from the first transceiver to the at least one device includes transmitting the at least one alterative signal to at least one component of the device.

27. The method of claim 23, further comprising forming a wireless coupling between the first and second transceivers.

28. The method of claim 27, wherein forming the wireless coupling is carried out by positioning the tool at a selected distance from the at least one device that is within the communication range of the first and second transceivers.

29. The method of claim 23, further comprising configuring the first and second transceivers so that they communicate with each other.

30. A method for monitoring and altering conditions of devices from a remote location, the method comprising:
transmitting respectively at least one signal from each of a plurality of devices to each of a plurality of first transceivers, wherein each signal is respectively indicative of at least one condition of each of the devices;
transmitting respectively each of the indicative signals at a different frequency from each of the plurality of first transceivers wirelessly to a second transceiver coupled to a tool that is adapted for at least one of monitoring and control of each of the plurality of devices;
transmitting each of the indicative signals from the second transceiver to the tool;
transmitting alterative signals from the tool to the second transceiver, wherein there is at least one signal for each of the plurality of devices, wherein each of the signals respectively alters at least one condition of each of the plurality of devices;
transmitting respectively each of the alterative signals at each of the different frequencies from the second transceiver to each of the plurality of first transceivers wirelessly;
transmitting respectively each of the alterative signals from each of the plurality of first transceivers to each of the plurality of devices; and
altering respectively at least one condition of each of the plurality of devices using each of the alterative signals.

31. The method of claim 30, further comprising evaluating each of the indicative signals at the tool and altering respectively at least one condition of each of the plurality of devices based on the evaluation.

32. The method of claim 30, wherein transmitting respectively at least one signal from each of a plurality of devices includes transmitting respectively the signal from at least one component of each of the plurality of devices.

33. The method of claim 30, wherein transmitting respectively each of the alterative signals from each of the first transceivers to each of the plurality of devices includes transmitting the alterative signal to at least one component of each of the plurality of devices.

34. The method of claim 30, further comprising forming a wireless coupling between each of the plurality of first transceivers and the second transceiver.

35. The method of claim 34, wherein forming the wireless coupling is carried out by positioning the tool at a selected distance from each of the plurality of devices that is within the communication range of each of the plurality of first transceivers and the second transceiver.

36. The method of claim 30, further comprising configuring the second transceiver and each of the plurality of first transceivers so that each of the plurality of first transceivers can respectively communicate at the different frequencies with the second transceiver.

37. A method for monitoring and altering conditions of devices from a remote location, the method comprising:
transmitting at least one signal from at least one component of at least one device to a first transceiver that is indicative of at least one condition of the component;
transmitting the at least one indicative signal wirelessly from the first transceiver to a second transceiver coupled to a tool that is adapted for at least one of monitoring and control of the at least one component;
transmitting the at least one indicative signal from the second transceiver to the tool;
evaluating the at least one indicative signal at the tool;
transmitting at least one alterative signal based on the evaluation from the tool to the second transceiver;
transmitting the at least one alterative signal wirelessly from the second transceiver to the first transceiver;
transmitting the at least one alterative signal from the first transceiver to the at least one component; and
altering the condition of the at least one component based on the evaluation using the at least one alterative signal.

38. A method for monitoring and altering conditions of devices from a remote location, the method comprising:
transmitting respectively at least one signal from at least one component of each of a plurality of devices to each of a plurality of first transceivers, wherein each signal is respectively indicative of at least one condition of the at least one component of each of the plurality of devices;
transmitting respectively each of the indicative signals at a different frequency from each of the plurality of first transceivers wirelessly to a second transceiver coupled to a tool that is adapted for at least one of monitoring and control of the at least one component of each of the plurality of devices;
transmitting each of the indicative signals from the second transceiver to the tool;
evaluating each of the indicative signals at the tool;
transmitting alterative signals based on the evaluation from the tool to the second transceiver, wherein there is at least one signal for the at least one component of each of the plurality of devices, wherein each of the signals respectively alters at least one condition of the at least one component of each of the plurality of devices;
transmitting respectively each of the alterative signals at each of the different frequencies from the second transceiver to each of the plurality of first transceivers wirelessly;
transmitting respectively each of the alterative signals from each of the first transceivers to the at least one component of each of the plurality of devices; and
altering respectively at least one condition of the at least one component of each of the plurality of devices using each of the alterative signals.

39. A method for monitoring and altering conditions of devices from a remote location, the method comprising:
coupling a first transceiver to at least one component of at least one device;
coupling a second transceiver to a tool that is adapted for at least one of monitoring and control of the at least one component;
configuring the first and second transceivers so that they communicate with each other;
forming a wireless coupling between the first and second transceivers;
transmitting at least one signal from the at least one component to the first transceiver that is indicative of at least one condition of the at least one component;
transmitting the at least one indicative signal wirelessly from the first transceiver to the second transceiver;
transmitting the at least one indicative signal from the second transceiver to the tool;
evaluating the at least one indicative signal at the tool;
transmitting at least one alterative signal based on the evaluation from the tool to the second transceiver;
transmitting the at least one alterative signal wirelessly from the second transceiver to the first transceiver;
transmitting the at least one alterative signal from the first transceiver to the at least one component; and
altering the condition of the at least one component based on the evaluation using the at least one alterative signal.

40. The method of claim 39, wherein forming the wireless coupling is carried out by positioning the tool at a selected distance from the at least one device that is within the communication range of the first and second transceivers.

41. A method for monitoring and altering conditions of devices from a remote location, the method comprising:
coupling respectively at least one component of each of a plurality of devices to each of a plurality first transceivers;
coupling a second transceiver to a tool that is adapted for at least one of monitoring and control of the at least one component of each of the plurality of devices;
configuring the second transceiver and each of the plurality of first transceivers so that each of the plurality of first transceivers can respectively communicate at a different frequency with the second transceiver;
forming a wireless coupling between each of the plurality of first transceivers and the second transceiver;
transmitting respectively at least one signal from the at least one component of each of the plurality of devices to each of the plurality of first transceivers, wherein each signal is respectively indicative of at least one condition of the at least one component of each of the plurality of devices;
transmitting respectively each of the indicative signals at each of the different frequencies from each of the plurality of first transceivers wirelessly to the second transceiver;
transmitting each of the indicative signals from the second transceiver to the tool;
evaluating each of the indicative signals at the tool;
transmitting alterative signals based on the evaluation from the tool to the second transceiver, wherein there is at least one alterative signal for the at least one component of each of the plurality of devices, wherein each of the alterative signals respectively alters at least one condition of the at least one component of each of the plurality of devices;
transmitting respectively each of the alterative signals at each of the different frequencies from the second transceiver to each of the plurality of first transceivers wirelessly;
transmitting respectively each of the alterative signals from each of the plurality of first transceivers to the at least one component of each of the plurality of devices; and
altering respectively at least one condition of the at least one component of each of the plurality of devices using each of the alterative signals.

42. The method of claim 41, wherein forming the wireless coupling is carried out by positioning the tool at a distance from each of the plurality of devices that is within the communication range of each of the plurality first transceivers and the second transceiver.
